(19) United States
(12) Patent Application Publication
(10) Pub. No.: US 2026/0326059 A1
(43) Pub. Date: Oct. 22, 2026

(54) METHODS AND TOOLS RELATING TO CATALYST CARRIERS

(71) Applicant: JOHNSON MATTHEY DAVY TECHNOLOGIES LIMITED, London (GB)

(72) Inventors: Ben Geoffrey MALLAM, Stockton-On-Tees (GB); Jay Simon CLARKSON, Stockton-On-Tees (GB); Andrew ROBINSON, Stockton-On-Tees (GB)

(21) Appl. No.: 19/105,599

(22) PCT Filed: Sep. 14, 2023
(86) PCT No.: PCT/GB2023/052383

§ 371 Date: Feb. 21, 2025

(30) Foreign Application Priority Data
Sep. 16, 2022 (GB) 2213603.0

(51) Int. Cl. B01J 8/02

(52) U.S. Cl. CPC B01J 8/02; B01J 2208/06

(57) ABSTRACT

Some embodiments are directed toward a method of removing a catalyst carrier engaged in a reactor tube of a tubular reactor. The method can include inserting a retrieval tool through an open end of the reactor tube and extending the retrieval tool along the reactor tube to contact and engage the catalyst carrier; and subsequently applying a force to the retrieval tool to attempt to dislodge the catalyst carrier and displace the catalyst carrier towards the open end of the reactor tube. The retrieval tool can include a head portion including a plurality of sprung-mounted arms, a handle portion, and an elongate body extending between the head portion and the handle portion.

Engaging the retrieval tool with the catalyst carrier can include engaging the sprung-mounted arms of the head portion with one or more features formed in the catalyst carrier.

### CROSS-REFERENCE TO RELATED APPLICATIONS

This application is a national phase filing under 35 C.F.R. § 371 of and claims priority to PCT Patent Application No. PCT/GB2023/052383, filed on Sep. 14, 2023, which claims the priority benefit under 35 U.S.C. § 119 of British Patent Application No. 2213603.0, filed on Sep. 16, 2022, the contents of which are hereby incorporated in their entireties by reference.

### FIELD OF THE DISCLOSURE

The present disclosure relates to a method of removing a catalyst carrier engaged in a reactor tube of a tubular reactor and a retrieval tool for use in such methods.

### BACKGROUND

Conventional, so-called fixed-bed tubular, reactors comprise a reactor shell containing a plurality of tubes, which are usually cylindrical, and which are usually directly filled with catalyst particles. In use, a heat-transfer medium flows through the shell of the reactor outside these tubes and thereby adjusts the temperature of the catalyst in the tubes by heat exchange across the tube wall. Thus, where the reaction is an exothermic reaction, the heat-transfer medium will allow heat to be removed from the catalyst and where the reaction is an endothermic reaction, the heat-transfer medium will provide heat to the catalyst.

For some reactions, the heat effects of the reaction are moderate such that they are either not problematic or they can be readily managed. In some cases, the heat effects are sufficiently small that large-diameter tubes may be used. This has the benefit that there is a large volume of catalyst within the tube.

However, for more exothermic or endothermic reactions it is necessary that there is efficient heat transfer via the tube wall to the heat transfer medium to enable the conditions within the reactor to be controlled, in order to maintain a stable operating temperature to avoid detrimental effects occurring. Such effects, for exothermic reactions, may include side reactions taking place, damage to the catalyst such as by sintering of the catalytic active sites, and, in a worst case, thermal runaway. Detrimental effects for endothermic reactions may include quenching of the reaction.

To achieve the desired efficiency, the surface area of the tube wall per unit length has to be maximised. This has in the past been achieved by installing a greater number of smaller-diameter tubes. In some reactions, the size restriction means that the tubes are only of the order of about 15 to 40 mm internal diameter. However, the use of this multiplicity of tubes increases the cost and complexity of the reactor.

Thus, in an attempt to mitigate these problems, an alternative approach has been developed, in particular for more exothermic or endothermic reactions, in which the catalyst is not directly packed into the reactor tubes but is instead contained in a plurality of catalyst carriers that are configured to sit within the reactor tube.

WO2011/048361, WO2012/136971, WO2016/050520 and WO2022/064211 describe some examples of catalyst carriers configured for use in tubular reactors.

Catalyst carriers may usefully be used for a wide range of processes. Examples of suitable uses include processes and reactors for exothermic reactions such as reactions for the production of methanol, reactions for the production of ammonia, methanation reactions, shift reactions, oxidation reactions such as the formation of maleic anhydride and ethylene oxide reactions and the like. A particular example where catalyst carriers may be used is in processes and reactors for performing the Fischer-Tropsch reaction. Catalyst carriers may also be used for endothermic reactions such as pre-reforming, dehydrogenation and the like.

Each reactor tube may contain a large number of catalyst carriers, and a single tubular reactor may contain a large number of reactor tubes. A number of catalyst carriers may require removal from the top of the tube, for example, because the catalyst has been poisoned. A reasonable force may be required because the carrier may have a tight fit against the tube wall.

### SUMMARY OF THE DISCLOSURE

In a first aspect of the present disclosure there is provided a method of removing a catalyst carrier engaged in a reactor tube of a tubular reactor, the method comprising:
i) inserting a retrieval tool through an open end of the reactor tube and extending the retrieval tool along the reactor tube to contact and engage the catalyst carrier; and
ii) subsequently applying a force to the retrieval tool to attempt to dislodge the catalyst carrier and displace the catalyst carrier towards the open end of the reactor tube;
the retrieval tool comprising a head portion comprising a plurality of sprung-mounted arms, a handle portion, and an elongate body extending between the head portion and the handle portion;
wherein engaging the retrieval tool with the catalyst carrier comprises engaging the sprung-mounted arms of the head portion with one or more features formed in the catalyst carrier.

Beneficially, the method provides a means to remove catalyst carriers which are tightly fit with the wall of a reactor tube without removing all of the carriers, and which are unable to be removed using other means. This may permit the use of the reactor tube to be maintained leading to improved efficiency of operation of the tubular reactor.

In some examples, extending the retrieval tool along the reactor tube comprises connecting together a plurality of connectable elements of the elongate body to increase the separation between the head portion and the handle portion such that the handle portion remains accessible from outside the reactor tube.

In preferred examples, the catalyst carrier is frictionally engaged in a reactor tube. Put another way, there is a sliding seal between the catalyst carrier and the reactor tube. Beneficially, the method may also permit removal of stuck catalyst carriers from any location along the length of the reactor tube. Accordingly, the first aspect may be a method of removing a catalyst carrier stuck in a reactor tube.

In some examples, the one or more features comprise one or more apertures, one or more lips, or one or more recesses formed in the catalyst carrier.

In some examples, the open end of the reactor tube is a lower end of the reactor tube and engaging the retrieval tool with the catalyst carrier comprises engaging the sprung-mounted arms of the head portion with a bottom end of the catalyst carrier.

In some other examples, the open end of the reactor tube is an upper end of the reactor tube and engaging the retrieval tool with the catalyst carrier comprises engaging the sprung-mounted arms of the head portion with an upper end of the catalyst carrier.

In some examples, engaging the retrieval tool with the catalyst carrier comprises inserting the sprung-mounted arms into a skirt portion of the catalyst carrier that comprises one or more apertures and biasing the sprung-mounted arms in a radially-outwards direction so as to engage the sprung-mounted arms into the one or more apertures by extending the sprung-mounted arms outwardly. In some examples, the skirt portion is at the upper end of the catalyst carrier. In some other preferred examples, the skirt portion is at the bottom end of the catalyst carrier.

In some other examples, engaging the retrieval tool with the catalyst carrier comprises inserting the sprung-mounted arms into a lid portion of the catalyst carrier that comprises an aperture and biasing the sprung-mounted arms in a radially-outwards direction so as to engage the sprung-mounted arms under a lip of the aperture by extending the sprung-mounted arms outwardly. In some examples, the lid portion is at the bottom end of the catalyst carrier. In some other preferred examples, the lid portion is at the upper end of the catalyst carrier. In some particularly preferred examples, the lid portion comprises a single, central aperture and the sprung-mounted arms are engaged under a lip of said single aperture.

The method may further comprise releasing the sprung-mounted arms from the one or more features of the catalyst carrier if the applied force is insufficient to dislodge the catalyst carrier and displace it towards the open end of the reactor tube.

In some examples, releasing the sprung-mounted arms comprises retracting the sprung-mounted arms to unclip each sprung-mounted arm from the feature with which it was engaged.

In some examples, retracting the sprung-mounted arms comprises pulling on a cable connected directly or indirectly to the or each sprung-mounted arm.

In some examples, one or more cables extend from the head portion to the handle portion and the one or more cables are pulled from the handle portion-end of the retrieval tool. In some examples, each cable connected to a sprung-mounted arm may be connected together at the head portion to a single length of cable that extends from the head portion to the handle portion. The single length of cable may comprise a single uninterrupted cable or may comprise a plurality of cables that are connected together in series. For example, the single length of cable may comprise separate cables that are interconnected by suitable means, for example by carabiner clip connectors.

In examples where the elongate body of the retrieval tool comprises a plurality of connectable elements to increase the separation between the head portion and the handle portion, the one or more cables extending from the head portion to the handle portion may preferably comprise a length of cable that can be wound onto and unwound from a reel to decrease and increase its effective length as required, or a plurality of cables that may be connected together in series as described above as the length of the elongate body is increased and disconnected from each other as the length of the elongate body is decreased.

In some examples, the force to dislodge the catalyst carrier is applied by an external mechanism that is coupled to the elongate body and/or handle portion.

In some other examples, the force to dislodge the catalyst carrier is applied by a slide hammer of the retrieval tool or other suitable external mechanism that can apply an impulse to the elongate body of the retrieval tool.

In a second aspect of the present disclosure there is provided a retrieval tool for removing a catalyst carrier from a reactor tube of a tubular reactor, the retrieval tool comprising:
a head portion comprising a plurality of sprung-mounted arms configured to engage with one or more features formed in the catalyst carrier;
a handle portion; and
an elongate body extending between the head portion and the handle portion; wherein the elongate body comprises a plurality of connectable elements for selectively increasing and decreasing the separation between the head portion and the handle portion.

In some examples, the sprung-mounted arms are configured to be insertable within a skirt portion or lid portion of the catalyst carrier that comprises one or more apertures, and the sprung-mounted arms are biased in a radially-outwards direction so as to engage the sprung-mounted arms into and/or through the one or more apertures. The skirt portion may be provided at the upper end of the catalyst carrier but is more typically provided at the bottom end of the catalyst carrier. The lid portion may be provided at the bottom end of the catalyst carrier but is more typically provided at the upper end of the catalyst carrier.

In some examples, the or each sprung-mounted arm comprises a hook element at its distal end. Preferably, the hook element faces radially-outwardly.

In some examples, the sprung-mounted arms comprise two, three, four or more arms.

The retrieval tool may further comprise a release mechanism for disengaging the sprung-mounted arms from the one or more features of the catalyst carrier.

In some examples, the release mechanism comprises a retracting element connected to each of the sprung-mounted arms for moving each sprung-mounted arm against its bias to disengage each sprung-mounted arm from the feature with which it was engaged.

In some examples, each retracting element comprises a cable connected to the sprung-mounted arm.

Preferably each cable is connected at or near a distal end of the sprung-mounted arm.

As noted above, each cable connected to a sprung-mounted arm may be connected together at the head portion to a single length of cable that extends from the head portion to the handle portion. The single length of cable may comprise a single uninterrupted cable or may comprise a plurality of cables that are connected together in series. For example, the single length of cable may comprise separate cables that are interconnected by suitable means, for example by carabiner clip connectors.

In some examples at least one cable extends from the head portion to the handle portion to allow a user to actuate the release mechanism from the handle portion-end of the retrieval tool. Preferably the at least one cable extends through an interior of the elongate body.

In some examples the handle portion comprises a handle coupled to the cable or cables extending from the head portion.

In some examples the connectable elements of the elongate body comprise threaded or bayonet connections. Other suitable means may be used.

In some examples the elongate body comprises an anchor point for a block and tackle, or other manual means for imparting force or impulse to the elongate body.

In some examples the elongate body comprises a slide hammer for applying an impulse to the head portion.

The catalyst carriers of the present disclosure may be filled or partially filled with any catalyst suitable for the intended reaction. For example, a Fischer-Tropsch catalyst may be used for the Fischer-Tropsch reaction. Cobalt-containing Fischer-Tropsch catalysts are preferred. The catalyst may be provided as catalyst particles or a catalyst monolith. The catalyst may be provided as a single bed of catalyst or multiple beds of catalyst. The catalyst carrier may be configured to promote axial and/or radial flow through the catalyst. In some embodiments the catalyst carrier may be configured to preferentially promote radial flow through the catalyst.

The catalyst carrier of the present disclosure may be formed of any suitable material. Such material will generally be selected to withstand the operating conditions of the tubular reactor. The catalyst carrier may be fabricated from carbon steel, aluminium, stainless steel, other alloys or any material able to withstand the reaction conditions.

### BRIEF DESCRIPTION OF THE DRAWINGS

Embodiments of the present disclosure will now be described, by way of example only, with reference to the accompanying drawings, in which:

FIG. 1 is a schematic side view of a tubular reactor;

FIG. 2 shows a catalyst carrier;

FIG. 3 is a schematic illustration of a retrieval tool according to the present disclosure in use;

FIG. 4 is a side elevation of a first embodiment of retrieval tool according to the present disclosure;

FIG. 5 is a close-up view of a head portion of the retrieval tool of FIG. 4 in a first configuration;

FIG. 6 is a close-up view of the head portion in a second configuration;

FIG. 7 is a close-up view of the head portion of the retrieval tool of FIG. 4 engaged with the catalyst carrier of FIG. 2;

FIG. 8 is a close-up view of a handle portion of the retrieval tool of FIG. 4;

FIG. 9 is a schematic illustration of a second embodiment of retrieval tool according to the present disclosure;

FIG. 10 is a view of a head portion of a third embodiment of retrieval tool according to the present disclosure;

FIG. 11 is a view of a lid portion of the catalyst carrier of FIG. 2; and

FIG. 12 is a view of the head portion of the retrieval tool of FIG. 10 engaged with the lid portion of the catalyst carrier of FIG. 11.

### DETAILED DESCRIPTION

In the following, aspects and embodiments of the present disclosure will be described, by way of example only, with reference to a vertically orientated tubular reactor having a plurality of vertical reactor tubes extending between an upper tube sheet and a lower tube sheet. However, it will be understood that the present disclosure may also be applied to other configurations of tubular reactor that may adopt other orientations.

Additionally, in this specification any reference to orientation; for example, terms such as top, bottom, upper, lower, above, below and the like is used with regard to the orientation of the parts as illustrated in the drawings being referenced but is not to be seen as restrictive on the potential orientation of such parts in actual use. For example, a part described as being orientated vertically may also be orientated horizontally.

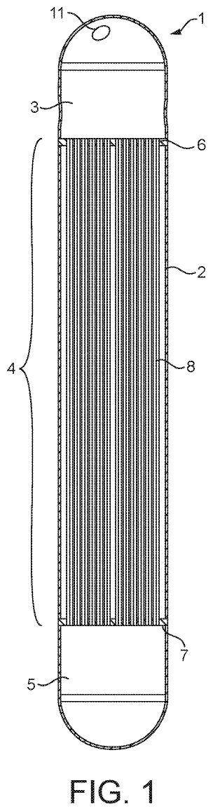

FIG. 1 shows a typical layout of a tubular reactor 1 of the present disclosure. The tubular reactor 1 comprises a housing 2. The interior of the housing may be divided into a head space 3, a heat-exchange zone 4 and a footer space 5 by two tube sheets-an upper tube sheet 6 and a lower tube sheet 7. The upper tube sheet 6 separates the head space 3 from the heat-exchange zone 4. The lower tube sheet 7 separate the footer space 5 from the heat-exchange zone 4.

A plurality of reactor tubes 8 extend between the upper tube sheet 6 and the lower tube sheet 7. A large number of reactor tubes 8 may be provided, for example between 20 and 5000 reactor tubes 8 may be present. Each reactor tube 8 may have, for example, an internal diameter of between 20 and 150 mm. In some embodiments the internal diameter may be about 85 mm.

Each reactor tube 8 is intended to be filled or substantially filled with a stacked arrangement of catalyst carriers 10. In particular, it is typically desired that the catalyst carriers 10 cover all or substantially all of the length of the reactor tube 8 between the upper tube sheet 6 and the lower tube sheet 7, i.e. that they cover all or substantially all of the length of the heat-exchange zone 4.

The head space 3 may provide access to an upper end of the reactor tubes 8 to allow loading of the catalyst carriers 10 into the reactor tubes 8. An access opening 11 may be provided in the housing 2 to allow access to the head space 3. The access opening 11 may, for example, be a manhole or other access panel that can be selectively opened and closed.

The footer space 5 may provide access to the lower end of the reactor tubes 8 to allow unloading of the catalyst carriers 10 from the reactor tubes 8.

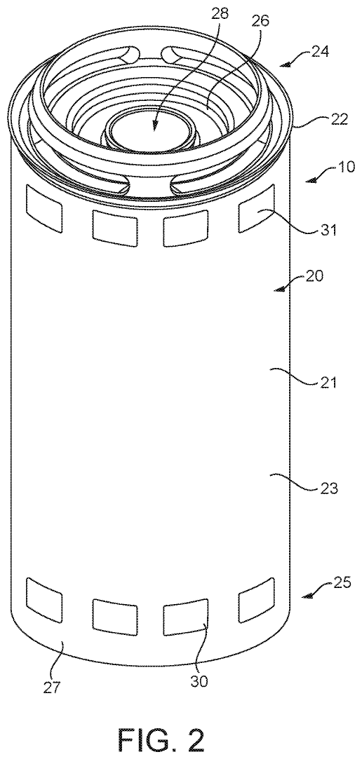

To better understand the present disclosure, an example of a general configuration of a catalyst carrier 10 will be described with reference to FIG. 2. However, it will be understood that the catalyst carriers 10 may take various forms. For example, as well as the example described herein, the catalyst carriers 10 may take other general configurations including but not limited to those disclosed in WO2011/048361, WO2012/136971, WO2016/050520 and WO2022/064211, the contents of which are herein incorporated by reference in their entirety.

Each catalyst carrier 10 may generally comprise a container 20 that is sized such that it is of a smaller dimension than the internal dimension of the reactor tube 8 into which it is to be placed in use. Typically, a seal 22 will be provided that is sized such that it interacts with the inner wall of the reactor tube 8 when the catalyst carrier 10 is in position within the reactor tube 8. Parameters such as carrier length and diameter may be selected to accommodate different reactions and configurations of reactor tube 8.

As shown in FIG. 2, the container 20 comprises an elongate body 21 having an outer wall 23 extending between an upper end 24 and a bottom end 25. A lid portion 26 is provided at the upper end 24 that at least partially closes off the elongate body 21 at the upper end 24. A skirt portion 27 is provided at the bottom end 25. The seal 22 is located towards the upper end 24 and preferably close to, for example just below, the lid portion 26.

The lid portion 26 is provided with a central aperture 28 that permits ingress of fluid, i.e. gas or liquid, usually a gas, into the container 20 in use. The central aperture 28 may be circumscribed by a lip 29, as most easily seen in FIG. 11, that extends inwardly into an interior of the container 20.

As shown in FIG. 2, the outer wall 23 may be provided with a plurality of apertures configured to permit fluid transfer across the outer wall 23. At the bottom end 25 of the outer wall 23, the skirt portion 27 may comprise a plurality of bottom apertures 30. The bottom apertures 30 may be spaced around the circumference of the elongate body 21. Each bottom aperture 30 may be, for example, of a square or rectangular shape. Similarly, at the upper end 24 of the outer wall 23, a plurality of upper apertures 31 may be provided. The upper apertures 31 may be spaced around the circumference of the elongate body 21. Each upper aperture 31 may be, for example, of a square or rectangular shape.

The catalyst carrier 10 may define an annular container for holding catalyst in use. The annular container may comprise a perforated inner container wall 35 (visible in FIG. 11) that defines an inner channel and a perforated outer container wall that may be concentrically arranged about the perforated inner container wall and within the outer wall 23. An annular top surface, defined by a part of the lid portion 26, may close an upper end of the annular container and an annular bottom surface may close a lower end of the annular container.

The seal 22 may be sufficiently compressible to accommodate the smallest diameter of the reactor tube 8. The seal 22 may generally be a flexible, sliding seal. The seal 22 may engage, e.g. frictionally engage, against an inner surface of the reactor tube 8 such that liquids and gases passing along the reactor tube 8 are preferentially directed to flow through an interior of the catalyst carrier 10. The seal 22 may, for example, be configured to form a sliding seal, i.e. it is frictionally engaged, against the inner surface of the reactor tube 8.

In the illustrated example of FIG. 2, the seal 22 may comprise a deformable flange extending from the outer wall 23. The flange may be sized to be larger than the internal diameter of the reactor tube 8 such that as the catalyst carrier 10 is inserted into the reactor tube 8 it is deformed to fit inside and interact with the reactor tube 8.

Further details of the construction of such catalyst carriers 10 can be found in WO2011/048361, WO2012/136971 and WO2016/050520, the contents of which are herein incorporated by reference in their entirety.

According to the presently disclosed subject matter, a retrieval tool 100 may be provided to assist with removal of a catalyst carrier 10 from reactor tube 8.

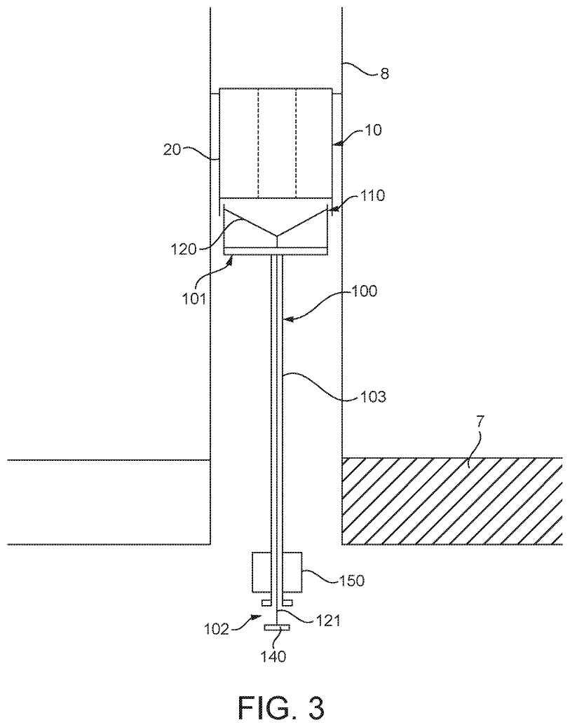

As shown in the schematic illustration of FIG. 3, the retrieval tool 100 comprises a head portion 101 comprising a plurality of sprung-mounted arms 110 configured to engage with one or more features formed in the catalyst carrier 10, a handle portion 102, and an elongate body 103 extending between the head portion 101 and the handle portion 102.

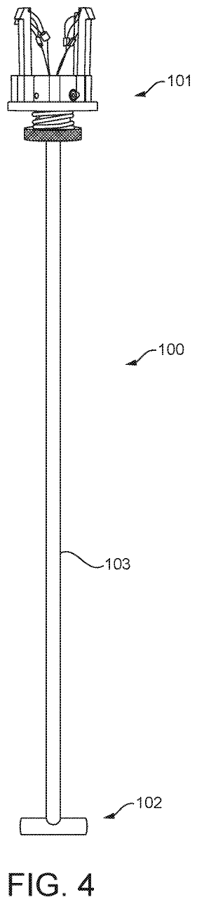

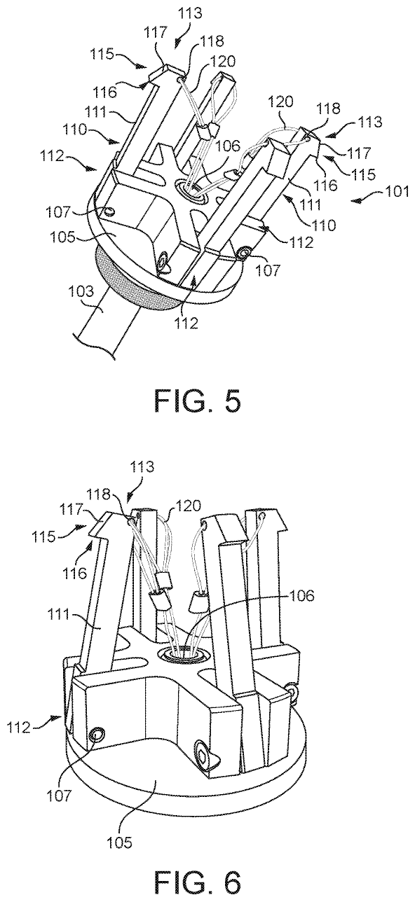

A first embodiment of a retrieval tool 100 is shown in more detail in FIGS. 4 to 8. In this embodiment, the elongate body 103 comprises a fixed length. The head portion 101 is shown in more detail in FIG. 5. The head portion 101 comprises a base portion 105 to which are mounted four sprung-mounted arms 110. The base portion 105 comprises a central aperture 106 that communicates with the elongate body 103. The sprung-mounted arms 110 are arranged around the central aperture 106.

Each sprung-mounted arm 110 comprises an elongate body 111 having a proximal end 112 and a distal end 113. The distal end 113 of each elongate body 111 comprises a hook element that may comprise a catch 115 that faces radially-outwards. An aperture 118 that receives a cable 120 is also provided. Each catch 115 comprises a catch surface 116 that is directed towards the handle portion 102 of the retrieval tool 100 and an angled ramp surface 117 that is directed generally away from the handle portion 102.

The proximal end 112 of each elongate body 111 is pivotally mounted to the base portion 105 at a pivot point 107. A biasing mechanism, for example a torsion spring acting at the pivot point 107, is provided for each elongate body 111 to bias the sprung-mounted arms 110 radially-outwards into the configuration shown in FIG. 5 in which the elongate bodies 111 are generally aligned with the longitudinal axis of the elongate body 103 of the retrieval tool 100.

The cables 120 of each sprung-mounted arm 110 are gathered together and connected to a main cable 121 that extends down an interior of the length of the elongate body 103 to the handle portion 102 where it is connected to a handle 140 as shown in FIG. 8.

As shown in FIG. 6, the sprung-mounted arms 110 can be pivoted about pivot points 107 against the bias to move the distal ends 113 of the sprung-mounted arms 110 radially-inwards. This action can be achieved by pulling on the handle 140 to pull the main cable 121 relative to the elongate body 103 which in turn pulls on the four cables 120 that act on the sprung-mounted arms 110. The cables 120 and main cable 121 thus provides a release mechanism for disengaging the sprung-mounted arms 110 from the catalyst carrier 10.

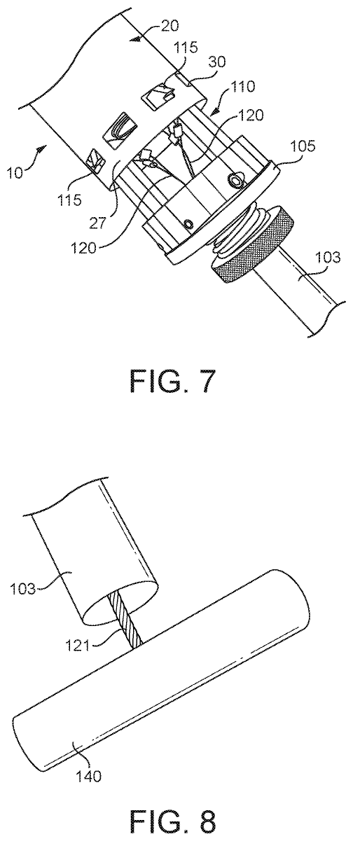

In use, as shown schematically in FIG. 3 and illustrated in FIG. 7, the sprung-mounted arms 110 insertable within the skirt portion 27 of the catalyst carrier 10 so as to engage the catches 115 of the sprung-mounted arms 110 into the bottom apertures 30 of the catalyst carrier 10. Connection of the head portion 101 to the bottom end 25 of the catalyst carrier 10 is accommodated by inward deflection/pivoting of the sprung-mounted arms 110 as the angled ramp surfaces 117 contact a lower rim of the bottom end 25 of the catalyst carrier 10 which forces the sprung-mounted arms 110 to pivot inwards as the head portion 101 is thrust into the skirt portion 27. Once fully engaged into the skirt portion, the sprung-mounted arms 110 are moved radially outwards so that the catches 115 project through the bottom apertures 30.

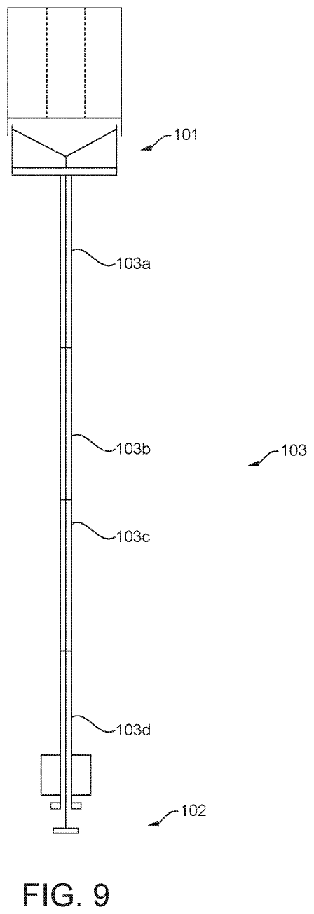

FIG. 9 illustrates a variant of the retrieval tool 100 wherein the elongate body 103 may comprise a plurality of connectable elements 103a-103d for selectively increasing and decreasing the separation between the head portion 101 and the handle portion 102. The connectable elements 103a-103d of the elongate body 103 may comprise, for example, threaded or bayonet connections.

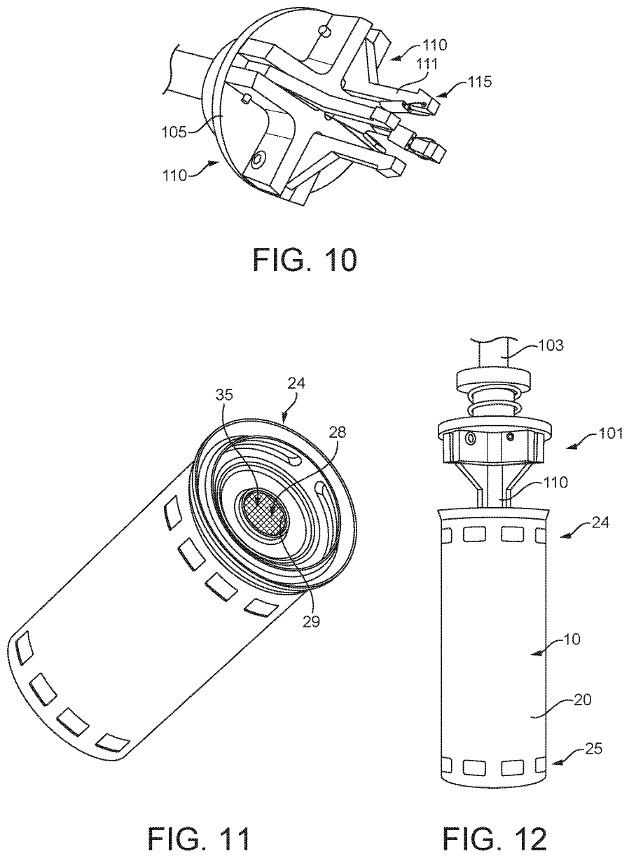

A second embodiment of a retrieval tool 100 is shown in more detail in FIGS. 10 to 12. In this embodiment, the head portion 101 is engaged with the upper end 24 of the catalyst carrier 10, an in particular with the lid portion 26. As shown in FIG. 10, the head portion 101 has a modified configuration in that the sprung-mounted arms 110 are located nearer the centre of the base portion 105, nearer the central aperture 106. Consequently, in the rest configuration shown in FIG. 10, the lateral span of the catches 115 is less than in the first embodiment. In this way the head portion 101 is configured for engagement with the central aperture 28 of the lid portion 26 rather than the skirt portion 27. As in the first embodiment, the sprung-mounted arms 110 are biased in a radially-outwards direction.

In use, the sprung-mounted arms 110 are inserted into the central aperture 28 of the lid portion 26 during which insertion the sprung-mounted arms 110 are pivoted/deflected radially inwards as the angled ramp surfaces 117 contact the rim of the central aperture 28 which forces the sprung-mounted arms 110 to pivot inwards as the head portion 101 is thrust into the central aperture 28. Once fully engaged into the central aperture 28, the sprung-mounted arms 110 are moved radially outwards so that the catches 115 catch against the lip 29 of the central aperture 28.

Optionally, the retrieval tool 100 of any embodiment may be provided with an anchor point for a block and tackle or with an integral slide hammer 150 for applying an impulse to the head portion 101 and/or the elongate body 103.

In use, to remove a catalyst carrier 10 the retrieval tool 100 is first inserted through an open end of the reactor tube 8. The open end may be the upper end or the bottom end of the reactor tube 8.

The retrieval tool 100 is extended along the reactor tube 8 to contact and engage the catalyst carrier 10. Engaging the retrieval tool 100 with the catalyst carrier 10 as discussed above comprises engaging the sprung-mounted arms 110 of the head portion 101 with one or more features formed in the catalyst carrier 10, for example the bottom apertures 30 of the skirt portion 27 or the lip 29 of the lid portion 26.

Subsequently, once engaged, a force is applied to the retrieval tool 100 to attempt to dislodge the catalyst carrier 10 and displace the catalyst carrier 10 towards the open end of the reactor tube 8.

1. A method of removing a catalyst carrier engaged a reactor tube of a tubular reactor, the method comprising:
i) inserting a retrieval tool through an open end of the reactor tube and extending the retrieval tool along the reactor tube to contact and engage the catalyst carrier; and
ii) subsequently applying a force to the retrieval tool to attempt to dislodge the catalyst carrier and displace the catalyst carrier towards the open end of the reactor tube;
the retrieval tool comprising a head portion comprising a plurality of sprung-mounted arms, a handle portion, and an elongate body extending between the head portion and the handle portion;
wherein engaging the retrieval tool with the catalyst carrier comprises engaging the sprung-mounted arms of the head portion with one or more features formed in the catalyst carrier.

2. The method of claim 1, wherein extending the retrieval tool along the reactor tube comprises connecting together a plurality of connectable elements of the elongate body to increase the separation between the head portion and the handle portion such that the handle portion remains accessible from outside the reactor tube.

3. The method of claim 1, wherein the one or more features comprise one or more apertures, one or more lips, or one or more recesses formed in the catalyst carrier.

4. The method of claim 1, wherein the open end of the reactor tube is a lower end of the reactor tube and engaging the retrieval tool with the catalyst carrier comprises engaging the sprung-mounted arms of the head portion with a bottom end of the catalyst carrier.

5. The method of claim 1, wherein the open end of the reactor tube is an upper end of the reactor tube and engaging the retrieval tool with the catalyst carrier comprises engaging the sprung-mounted arms of the head portion with an upper end of the catalyst carrier.

6. The method of claim 1, wherein engaging the retrieval tool with the catalyst carrier comprises inserting the sprung-mounted arms into a skirt portion of the catalyst carrier that comprises one or more apertures and biasing the sprung-mounted arms in a radially-outwards direction so as to engage the sprung-mounted arms into the one or more apertures by extending the sprung-mounted arms outwardly.

7. The method of claim 1, wherein engaging the retrieval tool with the catalyst carrier comprises inserting the sprung-mounted arms into a lid portion of the catalyst carrier that comprises an aperture and biasing the sprung-mounted arms in a radially-outwards direction so as to engage the sprung-mounted arms under a lip of the aperture by extending the sprung-mounted arms outwardly.

8. The method of claim 1, further comprising releasing the sprung-mounted arms from the one or more features of the catalyst carrier if the applied force is insufficient to dislodge the catalyst carrier and displace it towards the open end of the reactor tube.

9. The method of claim 8, wherein releasing the sprung-mounted arms comprises retracting the sprung-mounted arms to unclip each sprung-mounted arm from the feature with which it was engaged.

10. The method of claim 9, wherein retracting the sprung-mounted arms comprises pulling on a cable connected directly or indirectly to the or each sprung-mounted arm.

11. The method of claim 10, wherein one or more cables extend from the head portion to the handle portion and the one or more cables are pulled from the handle portion-end of the retrieval tool.

12. The method of claim 1, wherein the force to dislodge the catalyst carrier is applied by an external mechanism that is coupled to the elongate body and/or handle portion.

13. The method of claim 1, wherein the force to dislodge the catalyst carrier is applied by a slide hammer of the retrieval tool.

14. A retrieval tool for removing a catalyst carrier from a reactor tube of a tubular reactor, the retrieval tool comprising:
a head portion comprising a plurality of sprung-mounted arms configured to engage with one or more features formed in the catalyst carrier;
a handle portion; and
an elongate body extending between the head portion and the handle portion;
wherein the elongate body comprises a plurality of connectable elements for selectively increasing and decreasing the separation between the head portion and the handle portion.

15. The retrieval tool of claim 14, wherein the sprung-mounted arms are configured to be insertable within a skirt portion or lid portion of the catalyst carrier that comprises one or more apertures, and the sprung-mounted arms are biased in a radially-outwards direction so as to engage the sprung-mounted arms into and/or through the one or more apertures.

16. The retrieval tool of claim 14, wherein the or each sprung-mounted arm comprises a hook element at its distal end.

17. The retrieval tool of claim 14, wherein the sprung-mounted arms comprise two, three, four or more arms.

18. The retrieval tool of claim 14, further comprising a release mechanism for disengaging the sprung-mounted arms from the one or more features of the catalyst carrier.

19. The retrieval tool of claim 18, wherein the release mechanism comprises a retracting element connected to each of the sprung-mounted arms for moving each sprung-mounted arm against its bias to disengage each sprung-mounted arm from the feature with which it was engaged.

20. The retrieval tool of claim 19, wherein each retracting element comprises a cable connected to the sprung-mounted arm.

21. The retrieval tool of claim 20, wherein each cable is connected at or near a distal end of the sprung-mounted arm.

22. The retrieval tool of claim 20, wherein at least one cable extends from the head portion to the handle portion to allow a user to actuate the release mechanism from the handle portion-end of the retrieval tool.

23. The retrieval tool of claim 22, wherein the at least one cable extends through an interior of the elongate body.

24. The retrieval tool of claim 14, wherein the connectable elements of the elongate body comprise threaded or bayonet connections.
